(19) United States
(12) Patent Application Publication
(10) Pub. No.: US 2003/0096140 A1
(43) Pub. Date: May 22, 2003

(54) Magnetic recording medium

(75) Inventors: Hiroshi Tomiyasu, Tokyo (JP); Teiichiro Umezawa, Tokyo (JP); Tomotaka Yokoyama, Tokyo (JP); Takashi Sato, Singapore (SG)

Correspondence Address: COOK, ALEX, MCFARRON, MANZO,, CUMMINGS & MEHLER, LTD., Suite 2850, 200 West Adams St., Chicago, IL, 60606, US

(73) Assignee: Hoya Corporation

(21) Appl. No.: 10/228,491

(22) Filed: Aug. 27, 2002

(30) Foreign Application Priority Data
Aug. 29, 2001 (JP) 2001-260297
Jul. 24, 2002 (JP) 2002-215797

(51) Int. Cl. G11B 5/72

(52) U.S. Cl. 428/694 BS; 428/694 TS; 428/694 TB; 428/695

(57) ABSTRACT

By promoting isolation of magnetic grains in a surface of a magnetic layer and by introducing into the magnetic layer such a construction that includes a magnetic flux circuit easy for a recording magnetic field to penetrate into the magnetic layer of a magnetic recording medium, provided is the magnetic recording medium wherein high coercive force can be obtained, and as well an O/W property and an NLTS property can be enhanced, and an S/N ratio can also be enhanced, and resistance to thermal fluctuation is high, and a conventional tradeoff is avoided, and a manufacturing yield is excellent.

The magnetic recording medium comprises at least a substrate (10), a magnetic layer (60) formed on the substrate, and a segregation promoting layer (70) formed on the magnetic layer (60), wherein said segregation promoting layer (70) contains segregation promoting elements which diffuse into a surface layer portion of said magnetic layer to promote the isolation of magnetic grains in the surface layer portion.

### REFERENCE TO RELATED APPLICATION

This application claims the priority right under Paris Convention of Japanese Patent Application Nos. 2001-260297 filed on Aug. 29, 2001 and 2002-215797 filed on Jul. 24, 2002, the entire disclosure of which is incorporated herein by reference.

### BACKGROUND OF THE INVENTION

1. Field of the Invention

The present invention relates to a magnetic recording medium, particularly to a magnetic recording medium used for a HDD (hard disk drive).

2. Description of the Related Art

In recent years, due to demand for enhancement of recording density, a rapid increase in coercive force has continued in the case of a magnetic recording medium, especially a magnetic recording disk for HDD.

As to CoCrPt system ferromagnetic alloys, which have been conventionally used as a magnetic layer of a magnetic disk, increasing in coercive force has reached its limit and answering to the recent demand for increasing coercive force has become difficult. Therefore, lately has been employed for a magnetic layer a CoCrPtB system ferromagnetic alloy easy to be increased in coercive force wherein B is added to a conventional magnetic layer.

A magnetic layer comprising CoCrPtB system alloys is suitable for increasing coercive force, however, there has been a problem that the magnetic layer is poor in orientation property, even inferior in coercive squareness and consequently poorer in O/W property (Over Write property, overwriting property) compared with those of conventional magnetic layers. Further, there has been a problem that NLTS property (Non Linear Transition Shift property, Nonlinear bit shift property) is even poorer compared with those of conventional magnetic layers. The reason is considered to be dependent on the properties of B added to a magnetic layer for increasing a recording density.

Although explanation of magnetic recording characteristics such as O/W property, NLTS property is well known publicly known documents, etc., it is described in detail, for example, in “Storage Device Terminology edited by IDEMA Japan, Nikkei BP Co.” written by general engineers in the relevant technical field of the present invention.

O/W property is also referred to overwriting property, and when a new recording signal is overwritten on a formerly written signal on a magnetic recording medium in case of poor O/W property, the formerly written recording signal cannot sufficiently be erased overlapping with the new recording signal, causing an error, resulting in inability to read out accurate information.

Besides, NLTS property is a positional difference between an actual magnetization reversal position and the aimed position during recording a signal, and is also referred to nonlinear bit shift. In PRML encoding/decoding system, a technology which has made increasing recording density possible in recent years, since the influence of linear interference between codes is positively utilized, data decoding may be effected significantly by the presence of nonlinear positional difference (NLTS) in transition due to writing the codes. Consequently, it is an important issue to enhance NLTS property for a recording medium at present.

Now, as described above, O/W property and NLTS property are pointed out as the problems of CoCrPtB system alloys, and indeed it is well known that these recording characteristics are also influenced by coercive force (Hc). When coercive force (Hc) of a recording medium is high, magnetization of the recording medium becomes difficult to be recorded up to an aiming saturated state, resulting in degradation of an O/W property or an NLTS property.

Therefore, although CoCrPtB system alloys can be increased more in coercive force (Hc) compared to a conventional magnetic layer in order to correspond a recording density as described above, the fact may also cause degradation of the recording characteristics such as an O/W property, an NLTS property.

Although the problems of various characteristics as described above are the problems of a magnetic recording medium, there have appeared some problems of manufacturing process owing thereto.

As described above, since magnetic layers comprising CoCrPtB system alloys are featured in their high coercive force (Hc), a poor coercive squareness and having problems of an O/W property and an NLTS property they vary over-sensitively with such small process variations (for example a small variation in film thickness, a small variation in film formation rate, a small variation in a film formation temperature) that have not been problematic in the manufacturing process of magnetic recording mediums with a conventional magnetic layer and are consequently liable to be a variation factor in manufacturing yield of the magnetic recording mediums.

Further, when they are mounted on a magnetic recording device such as HDD, occurred is such a problem that manufacturing yield of the magnetic recording device is liable to vary due to variations in recording performance of a magnetic head on which they are mounted because of their poorer recording characteristics such as O/W property, NLTS property compared to a conventional magnetic layer.

For a method of solving these problems, it is proposed as described in U.S. Pat. No. 5,523,173 that a film of a magnetic layer is formed by applying −300 V, a negative bias on a substrate.

Moreover, for another method as described in U.S. Pat. No. 6,143,388, proposed is that an onset layer is inserted between a under layer and a magnetic layer. That is to say, it aims to improve orientation property of the magnetic layer formed afterwards by means of forming the onset layer with strong orientation property on the Cr-system under layer.

However, since the method of applying a negative bias proposed in U.S. Pat. No. 5,523,173 can be employed only for an electrically conductive substrate, it cannot be a radically improved method of a magnetic recording medium with a magnetic layer comprising CoCrPtB-system. Further, concerning the above problems, especially various problems relating to manufacture of magnetic recording mediums or magnetic recording devices, the method of inserting an onset layer proposed in U.S. Pat. No. 6.143,388 cannot have achieved the desired yield.

By the way, described above is increase in coercive force as a demand for high recording density of a magnetic recording medium, and on the other hand there has always been a demand for increasing in S/N ratio (Signal to Noise ratio: SNR).

Although there is a method of increasing Cr concentration in a magnetic layer as an ordinary method of improving S/N ratio, employment of this approach has been relatively difficult, because increase in Cr content degrades orientation property of the magnetic layer, especially for the magnetic layer comprising a CoCrPtB-system alloy with intrinsically poor orientation property.

As another method of improving S/N ratio, a method of decreasing film thickness of a magnetic layer, aiming low Mrt and reducing medium noises has also been difficult to be employed because decrease in film thickness results in degradation of orientation property.

Moreover, from the view point of increase in both coercive force and S/N ratio, there is a method of increasing Pt concentration in a magnetic layer as an ordinary method of increasing coercive force. However, since the atomic radius of Pt is larger than that of Co, the main component of the magnetic layer, increase in Pt concentration increases a lattice parameter of the magnetic layer. Although, main object of a under layer is attempting to increase coercive force by promoting epitaxial growth to enhance S/N ratio and by enhancing orientation property of a magnetic layer, the increase in the lattice parameter of the magnetic layer due to the increase in the Pt concentration enlarges difference in the lattice parameters between the under layer and the magnetic layer and acts in the direction of preventing epitaxial growth and orientation enhancement of the magnetic layer. Consequently, the increase in the Pt concentration aiming increase in coercive force results in degradation of S/N ratio and decrease in coercive force to the contrary.

In case of a CoCrPtB system magnetic layer intrinsically poor in orientation property compared to a conventional magnetic layer, increase in coercive force by increasing Pt content has been difficult because the above tradeoff are so remarkable.

Further, although an addition element B characteristic of a CoCrPtB system magnetic layer has an advantage of increasing S/N ratio due to its grain refinement effect in the magnetic layer, there is such a problem that increase in Pt concentration restrains the grain refinement effect and does not give an expected enhancement of S/N ratio, and from this point of view, increase in coercive force by increasing Pt content has been difficult.

With regard to the above problems, it has been difficult to overcome the problems and to promote increase in recording density by employing a magnetic layer comprising a CoCrPtB system alloy, which is recently being introduced and even by trying to improve it using publicly known art.

Besides, enhancement of a new property referred to a thermal fluctuation property has been required in recent years.

Thermal fluctuation is such a phenomenon that signals recorded onto a magnetic recording medium attenuates after a certain duration and the recorded signals reduces as low as a level of medium noise and finally the recorded signals are turned unable to be read out. This is due to the fact that, since increase in S/N ratio was tried in order to respond to demand for increasing recording density, refinement of magnetic grains in a magnetic layer has been executed too far for magnetization to be unable to withstand disturbance by thermal energy and thereby super paramagnetic state has been generated and consequently, thermomagnetic aftereffect has appeared remarkably. That is to say, an increase in S/N ratio and an enhancement of resistance against thermal fluctuation are in a tradeoff relationship with each other. Although increase in coercive force is counted one method of enhancing resistance against thermal fluctuation, the increase in coercive force is in a tradeoff relation with other magnetic properties or magnetic recording properties, and therefore it is difficult to find out a solution with ease.

As a result of earnest research and development on such a new magnetic layer that may overcome the problems born by modern magnetic layers and may respond to demand for high density recording, the present inventers have invented that a magnetic recording medium, with which high coercive force can be obtained, as well an O/W property and an NLTS property being able to be enhanced, an S/N ratio being able to be also enhanced, resistance to thermal fluctuation being able to be high, conventional tradeoff being able to be avoided and manufacturing yield being able to be excellent, can be obtained by promoting isolation of magnetic grains in a surface of the magnetic layer and by introducing into the magnetic layer such a construction that may include a magnetic flux circuit easy for a recording magnetic field to penetrate into the magnetic layer of the magnetic recording medium.

### SUMMARY OF THE INVENTION

In order to achieve the above objects, the present invention includes the following constituents.

(Constitution 1) A magnetic recording medium comprising at least: a substrate; a magnetic layer formed on the substrate; and a segregation promoting layer formed on the magnetic layer, wherein said segregation promoting layer contains segregation promoting elements which diffuse into a surface layer portion of said magnetic layer to promote the isolation of magnetic grains in the surface layer portion.

(Constitution 2) The magnetic recording medium described in constituent 1, wherein said segregation promoting layer is made of a material having a higher magnetic permeability than said magnetic layer.

(Constitution 3) The magnetic recording medium described in constituent 1 or 2, wherein said segregation promoting layer is made of a material containing Co and Cr as well as segregation promoting elements consisting of at least one element selected from Ta, W and C, and among the contents of the elements contained in said segregation promoting layer, the Cr content is in a range of 10 at % to 30 at % and the contents of the segregation promoting elements selected from Ta, W and C are in a range of 0.3 at % to 10 at %.

(Constitution 4) The magnetic recording medium described in anyone of the constituents from 1 to 3, wherein said magnetic layer is made of a material containing Co, Pt and B, and among the contents of the elements contained in said magnetic layer, the Pt content is in a range of 5 to 20 at % and the B content is in a range of 0.5 at % and 10 at %.

(Constitution 5) The magnetic recording medium described in anyone of the constituents from 1 to 4, wherein B is added in 0-10 at % to the surface of said segregation promoting layer.

(Constitution 6) The magnetic recording medium described in anyone of the constituents from 1 to 5, wherein a film thickness of said segregation promoting layer is 5-70 Å and still smaller than a film thickness of said magnetic layer.

(Constitution 7) A magnetic recording medium comprising at least: a substrate; a magnetic layer formed on the substrate; and an upper layer formed on the magnetic layer, wherein said magnetic layer is made of a material containing Co, Pt and B, and among the contents of the elements contained in said magnetic layer, the Pt content is in a range of 5 to 20 at % and the B content is in a range of 0.5 at % to 10 at %; and said upper layer is made of a material containing Co and Cr, and also at least one element selected from Ta, W and C, and among contents of the elements contained in said upper layer, the Cr content is in a range of 10 at % to 30 at % and the contents of the elements selected from Ta, W and C are in a range of 0.3 at % to 10 at %.

(Constitution 8) The magnetic recording medium described in constituent 7, wherein B is added in 0-10 at % to a surface of said upper layer.

(Constitution 9) The magnetic recording medium described in constituents 7 or 8, wherein a film thickness of said upper layer is 5-70 Å and still smaller than a film thickness of said magnetic layer.

(Constitution 10) The magnetic recording medium described in constituents 1 or 7, wherein said magnetic layer is separated by a spacer layer composed of a nonmagnetic substance, and the separated magnetic layers are in anti-ferromagnetic coupling state with each other.

By making a magnetic recording medium have such a configuration that an upper layer is formed on a surface of a magnetic layer and segregation promoting elements are contained in the upper layer in order to make the upper layer act as a segregation promoting layer and they are diffused into a neighborhood of the surface of the magnetic layer, said segregation promoting elements diffuse into a surface layer portion of the magnetic layer and they segregate around magnetic grains in the surface layer portion of the magnetic layer and the magnetic grains are isolated from one another making magnetic properties and magnetic recording properties of the surface layer portion of the magnetic layer enhanced.

That is to say, the magnetic recording medium is such as the magnetic properties of the surface layer portion are selectively modified. The effect of the segregation promoting elements thereon is suppressed except the surface layer portion of the magnetic layer because the segregation promoting elements are not diffused so much.

### BRIEF DESCRIPTION OF THE DRAWINGS

FIG. 1 is a cross-sectional structure of an embodiment of a magnetic recording medium according to the present invention.

FIG. 2 is a graph showing the relationship between a signal output and an O/W property.

FIG. 3 is a graph showing the relationship between a signal output and an NLTS property.

FIG. 4 is a graph showing the relationship between a signal output and an S/N ratio.

FIG. 5 is a graph showing the relationship between a Mrt and a coercive force(Hc).

FIG. 6 is a graph showing the relationship between a Mrt and a coercive squareness(S*).

FIG. 7 is a graph showing the relationship between a carrier signal recording density and a normalized medium noise.

FIG. 8 is a cross-sectional structure of another embodiment of the magnetic recording medium according to the present invention.

### DETAILED DESCRIPTION OF THE INVENTION

In this magnetic recording medium, O/W property and NLTS property can be improved attempting increase in coercive force and enhancement of a coercive squareness of the magnetic layer, and S/N ratio can also be enhanced improving resistance against thermal fluctuation.

As to the magnetic layer main body, the above-described design for increasing coercive force can be employed. As described above, increase in coercive force is advantageous to increasing recording density and is also able to enhance resistance against thermal fluctuation but, as also described above, the increase in coercive force ought to degrade orientation property of the magnetic layer, to generate accompanying decrease in the coercive squareness, to degrade O/W property and NLTS property and even to be disadvantageous to enhance S/N ratio. However, since said upper layer near the surface portion in the direction of film thickness of the magnetic layer has a high S/N ratio, a high O/W property and a high NLTS property, the magnetic recording medium can be released from the restraint by the tradeoff, which has been conventionally hard to be solved, by having selectively enhanced the magnetic properties and magnetic recording properties of the only surface portion of the magnetic layer, and it can be such as to be increased easily in recording density.

Further, stabilization of coercive force for a small process variation can be achieved and also the coercive squareness can be enhanced.

Through the above workings, manufacturing yield of magnetic recording mediums and magnetic recording devices can be increased.

Moreover, the fact that the upper layer comprises a material having a high magnetic permeability than the magnetic layer promotes the above-mentioned effect.

The reason is that having high permeability equals namely being easy to be penetrated therein by magnetic flux. By forming the upper layer comprising the material with high magnetic permeability than that of the magnetic layer, introduction and penetration of a recording magnetic field into the magnetic layer are promoted. As a result, the recording magnetic field is sufficiently introduced and penetrates into a lower portion of the magnetic layer (in the direction of approaching the substrate) and promote saturated recording throughout the total region of the magnetic layer. When there exist any regions in the magnetic layer in which the saturated recording has not been done without the upper layer concerned, magnetization reversal of this portion is broad and intensity of recording signal is small and medium noise is increased and therefore S/N ratio is degraded therein. And, the fact that saturated recording cannot be done equals that there exist the remaining former signals in case of overwriting and that O/W property is poor. Besides, while it is described above that NLTS property is a positional difference between an actual magnetization reversal position, which acts as a magnetically recorded information, and the aimed position during recording a signal on a medium by a magnetic head, and is referred to nonlinear bit shift, in the present invention, however, recording magnetic field from the magnetic head is easy to be introduced and to penetrate into a recording magnetic layer and an aimed accurate magnetic flux circuit can be formed during recording, because the upper portion of the recording magnetic layer is processed to have high magnetic permeability. Therefore, suppressing disturbance factors, which distort a writing magnetic field from the head and distort nonlinearly the magnetization reversal position undesirably, the magnetization reversal position can be accurately recorded on the aimed position.

Consequently, attempting increase in coercive force of a magnetic layer for higher recording density, a magnetic recording medium having high resistance against thermal fluctuation, enhanced recording properties such as an O/W property, an NLTS property, high S/N ratio, being released from mutual tradeoff restraint and easy to increase recording density can be obtained.

Further, since NLTS property and O/W property are enhanced, manufacturing yield of recording mediums and manufacturing yield of recording devices are also increased.

Besides, although stabilization of coercive force is achieved by a segregation promoting layer of said upper layer, a tendency toward slight decrease in coercive force about the Mrt is observed. Therefore, when Mrt is controlled to be 0.2-0.6 memu/cm², preferably 0.2-0.5 memu/cm², variation of coercive force due to process variation factors can be restrained to an extremely small amount resulting in high usefulness.

In order to restrain this tendency toward small decrease in coercive force by the segregation promoting layer, a thickness of the segregation promoting layer is good from 5-70 Å, preferably from 10-50 Å. Since the effect of said segregation promoting layer is too small with thickness less than 5 Å and the effect of small decrease in coercive force becomes evident with thickness more than 70 Å, and either case is not preferable.

Further, the film thickness of the segregation promoting layer is preferably smaller than that of the magnetic layer.

When the segregation promoting layer is thicker than the film thickness of the magnetic layer, decrease in signal output is liable to occur.

For a material used as the segregation promoting layer, preferable is such a magnetic material that includes a segregation promoting element Cr and also the segregation promoting elements such as Ta, W, C, and has high permeability. Since these segregation promoting elements promote segregation and are insoluble in Co, they are difficult to diffuse in the segregation promoting layer and thereby leach out into the surface layer of the magnetic layer and penetrate into the upper surface layer side of the magnetic layer and segregate around magnetic grains to isolate the magnetic grains with one another in the surface layer of the magnetic layer. When the above requirements are satisfied with a layer, the layer will function as the segregation promoting layer.

As a preferable material for the segregation promoting layer, from the requirement of high permeability and mutual insolubility with said segregation promoting elements, counted in are a Co-system alloy, especially a CoCr system alloy containing a segregation promoting element Cr and further a CoCrPt system alloy containing Pt in view of increasing coercive force. Further, CoCrTa system alloy and CoCrPtTa system alloy containing Ta characteristic as a segregation promoting element are preferable. In place of Ta or adding to Ta, W and C, with which the same segregation effect can be obtained, may be contained.

Ta, W and C content in these segregation promoting layers are preferably in a range of 0.3 at % to 10 at %, desirably in a range of 0.5 at % to 8 at %. Below 0.3 at % segregation promoting effect is too small and beyond 10 at % appears an action degrading orientation property of the magnetic layer. Materials and their compositional ratios can be appropriately adapted as far as said effects are not lost.

An advantage in case of containing Cr in a segregation promoting layer is that magnetic interaction between magnetic grains is urged to be isolated by Cr as a function of the segregation promoting layer. In a forming process of the magnetic layer, film formation of each layer after heating a substrate is an ordinary manner and a temperature relatively lowers when the magnetic layer is formed as a film. Magnetic isolation of magnetic grains by Cr is liable to be insufficient at a low substrate temperature, and consequently medium noise increases and S/N ratio is degraded.

However, by using the segregation promoting layer these problems can be solved and S/N ratio can be maintained.

The Cr content in the segregation promoting layer is preferably in a range of 10 at % to 30 at % and desirably in a range of 15 at % to 25 at %. Below 10 at % the above Cr effect is not evident and beyond 30 at % appears an effect decreasing saturation magnetization of the surface layer portion of the magnetic layer and either case is not preferable.

As to a far preferable embodiment of the magnetic recording medium according to the present invention, it is preferable that B is added to the surface, on the side opposite to the substrate, of the segregation promoting layer (that is, the surface on the magnetic head side of the segregation promoting layer). The reason is that by containing B in the surface side of the segregation promoting layer, AC medium noise can be reduced. Medium noise is generally contributed by DC medium noise and AC medium noise. Here, DC medium noise means medium noise existing after being erased by DC (that is, it corresponds to recording at 0 Hz of a recording frequency) and AC medium noise means medium noise existing after being recorded by AC (that is, high frequency recording).

Further, by means of the segregation promoting layer according to the present invention, it is possible to control cut width of DC medium noise and cut width of AC medium noise respectively, and balance of cut width of DC medium noise and AC medium noise can be controlled appropriately depending on the purpose.

A method to add B into the segregation promoting layer can be realized by employing such a method that the segregation promotion layer is configured to be multi-layered and a B containing material is used for the segregation promoting layer on the magnetic head side, or that B is implanted into the segregation promoting layer by ion implantation. Moreover, by combining these method, a magnetic layer—a segregation promoting layer structure or a magnetic layer—a segregation promoting layer—a B added segregation promoting layer structure can be formed by means of controlling the B concentration in the magnetic layer continuously or stepwise during formation of the magnetic layer.

Further, B content in the segregation promoting layer is preferably 0-10 at %, and desirably 0-8 at %. Beyond 10 at %, degradation effect on an orientation property will appear.

Besides, a material of the magnetic layer according to the present invention is not particularly confined.

For the magnetic layer, for example, counted are the alloy materials such as CoCrPtB system, CoCrPtTa system, CoCrPtNi system, CoCrPt system, CoCrNiTa system, CoCrTa system, CoCrNi system, CoCrPtTaB system. Among them, an alloy containing Pt is preferable for the present invention because it has the magnetic layer with high coercive force. Further, from the above-mentioned object, the present invention prefers the CoCrPtB system magnetic layer, which is easy to increase coercive force and has fine magnetic grains and can display the effect thereof.

Further, these magnetic layers may be separated by a nonmagnetic substance, a paramagnetic material, weak magnetic substance, anti-ferromagnetic substance, etc. in order to enhance S/N ratio or resistance against thermal fluctuation.

As described above, a magnetic layer, which is separated by a nonmagnetic substance in order to enhance resistance against thermal fluctuation is generally called as an AFC film (Anti-Ferro-Coupled-Film), namely an anti-ferromagnetic coupling film. In details, the structure of the magnetic layer concerned has a magnetic layer structure including a first magnetic layer comprising a ferromagnetic material for controlling anti-ferromagnetic exchange interaction, a second magnetic layer comprising a ferromagnetic material and a spacer layer formed between said first magnetic layer and said second magnetic layer, comprising a nonmagnetic substance for inducing the anti-ferromagnetic exchange interaction.

In this case, it is not necessary that the compositions and the film thicknesses of said first magnetic layer and said second magnetic layer separated by the spacer layer are the same, and they are appropriately adapted as far as the anti-ferromagnetic exchange interaction is not spoiled.

The magnetic layer comprising an AFC film can restrain thermal fluctuation phenomenon and thereby resistance against thermal fluctuation is enhanced because it is separated by a spacer layer comprising a nonmagnetic substance and said separated magnetic layers are coupled anti-ferromagnetic with each other via said spacer layer, and it is particularly preferable for the present invention.

There have been the problems for the magnetic layer comprising an AFC film that it is poor in an O/W property and an NLTS property compared to those of the magnetic layer without any AFC films because the former is separated with a spacer layer.

Since the operation-effect enhancing the O/W property and the NLTS property can be obtained according to the present invention, applying the present invention to a magnetic recording medium with an AFC film is especially useful, because of the ability to enhance resistance against thermal fluctuation without degradation of O/W property and the NLTS property.

In the present invention, it is preferable that the film thickness of said spacer layer comprising a nonmagnetic substance is 4 Å-10 Å, particularly 7 Å-9 Å because resistance against thermal fluctuation is enhanced through optimum interaction of anti-ferromagnetic coupling between the magnetic layers via the spacer layer.

It is preferable to use a material with hcp structure containing Ru for said spacer layer because the material is excellent in lattice coherency with the magnetic layer and promote epitaxial growth of the magnetic layer and can enhance the S/N ratio. For the material in this case Ru, CoRu, NiRu, etc. are counted. The case in which Ru is used is particularly preferable since the operation-effect provided by said spacer layer is high.

Additionally, when the magnetic layer is configured to be an AFC film structure, the film thickness of the first magnetic layer comprising a ferromagnetic material for controlling anti-ferromagnetic exchange interaction is preferably 5-80 Å. Below 5 Å or beyond 80 Å, operation-effect on controlling anti-ferromagnetic exchange interaction may turn insufficient. Further, using a Co alloy, especially a CoCr alloy is preferable for the first magnetic layer because resistance against thermal fluctuation is enhanced. When the CoCr alloy is used for the first magnetic layer, the compositional ratio of Cr less than 22 at % is preferable because operation-effect on controlling anti-ferromagnetic exchange interaction is increased. The compositional ratio of the magnetic layer is appropriately adapted depending on the magnetic properties and magnetic recording properties required. For example, Co: 45-89 at %, Pt: 5-20 at %, B: 0.5-10 at % is preferable for the magnetic layer of CoPtB system alloy and Cr: 5-25 at % for the magnetic layer additionally containing Cr.

The film thickness of the magnetic layer is constrained to some extent in order to obtain the desired Mrt and is appropriately adapted depending on the composition of the magnetic layer.

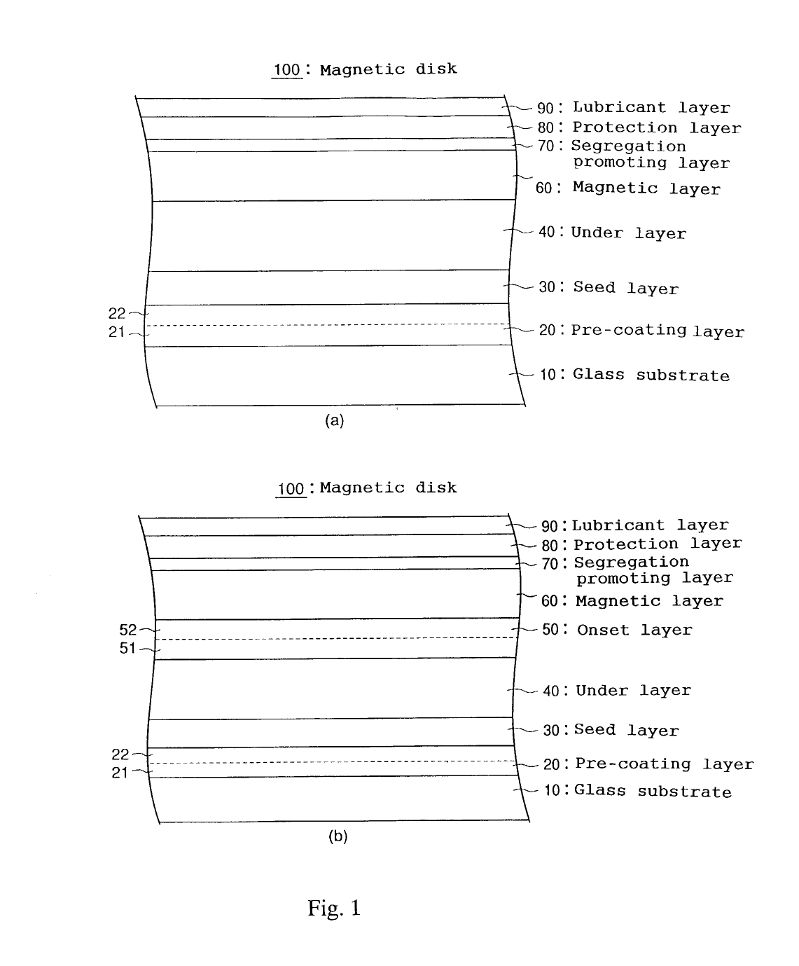

Further, an onset layer 50 (a non-ferromagnetic onset layer 51, a ferromagnetic onset layer 52) shown in FIG. 1B can be formed between an under layer 40 and a magnetic layer 60 .

For the non-ferromagnetic onset layer 51 counted are CoCr system alloy (Cr>30 at %) for example, CoCr, CoCrB, CoCrNb, etc. and CoRu, Ru, Os and for the ferromagnetic onset layer 52 counted are for example, CoCrPtTa, CoCrPt, CoPtTa, CoPt, CoCrTa, CoCrPtTaB, etc.

The film thickness of the onset layer is appropriately adapted depending on coercive force and Mrt of the magnetic layer 60. It is preferably 10-80 Å, more preferably 15-60 Å.

Further, when the onset layer comprises the non-ferromagnetic onset layer 51 and the ferromagnetic onset layer 52, the preferable range of each film thickness is desirably 5-15 Å and 10-40 Å. Still further, the film thickness ratio of the non-ferromagnetic onset layer 51 to the ferromagnetic onset layer 52 (the film thickness of the non-ferromagnetic onset layer/the film thickness of the ferromagnetic onset layer) is desirably 3/2-⅛.

Further, O, N, C, H, etc. may be added into these onset layers in order to enhance S/N ratio in view of refinement of crystalline grain size.

As the method of adding these elements into the onset layer, there are a method wherein film formation is executed by spattering under an inert gas atmosphere with a spattering target containing these elements and a method wherein the film formation is carried out under a mixed gas atmosphere of oxygen gas, nitrogen gas, nitrogen monoxide gas, nitrogen dioxide gas, carbon monoxide gas, carbon dioxide gas, methane gas, ammonia gas, cyan gas, water, or etc. mixed with inert gas by a reactive spattering process and some others.

In this case, it is preferable to add these elements into the non-ferromagnetic onset layer 51 and not to add these elements into the ferromagnetic onset layer 52. The reason is because magnetization of the ferromagnetic onset layer 52 is reduced by the addition of these elements and the function of the ferromagnetic onset layer is lowered.

Besides, the segregation promoting layer according to the present invention does not need to particularly confine a record-regeneration system of the magnetic recording medium as recognized from the foregoing discussion on the object and the mechanism thereof. That is to say, it is also effective in a magnetic recording medium used for a perpendicular recording system as well as in a longitudinal recording system.

Further, it is preferable to heat-treat the segregation promoting layer within the temperature range of a room temperature −300° C., before and /or after the formation thereof, for enhancing the operation-effect of the segregation promoting layer according to the present invention. The reason is because the treatment helps the segregation promoting elements contained in the segregation promoting layer penetrate into the surface layer portion of the magnetic layer.

In the following, the magnetic recording medium of the present invention will be described further with some examples. For further comparison, some comparisons will also be described.

### EXAMPLES 1-5, EXAMPLES 7-9, COMPARISONS 1-5

As shown in FIG. 1, the magnetic recording medium of the present examples is a magnetic disk 100 wherein a pre-coating layer 20, a seed layer 30, an under layer 40, an onset layer 50, a magnetic layer 60, a segregation promoting layer 70, a protection layer 80 and a lubricant layer 90 are formed sequentially on a glass substrate 10.

The glass substrate is composed of a chemically reinforced aluminosilicate glass and its surface is mirror-polished in the surface roughness of Rmax=3.2 nm, Ra=0.3 nm.

The pre-coating layer comprises two alloy layers and an alloy film 21 of a lower layer is composed of a nitride film of NiP (film thickness: 300 Å) and an alloy film 22 of an upper layer is composed of a nitride film of CrZr (film thickness: 30 Å). The atomic compositional ratio of Ni to P in the alloy 21 is 80:20. And, the atomic compositional ratio of Cr to Zr in the alloy 22 is 60:40. The nitrogen content in the alloy film 20 with two layers 4 at %. Each of the two-layered alloy film 20 is continuously formed as a film by spattering under a mixed gas atmosphere with Ar: 50% and N₂: 50%.

After heating the substrate at 200° C., the alloy layer 20 is formed as a film by spattering under a preheated condition.

The seed layer 30 is formed of a NiAl thin film, after heating the substrate again at 200° C. The NiAl thin film includes the compositional ratio of Ni: 50 at % and Al: 50 at %.

The under layer 40 comprising a CrV thin film (film thickness: 100 Å) is disposed in order to control the crystalline structure and the orientation property of the magnetic layer 60. The CrV thin film has the compositional ratio of Cr: 80 at % and V: 20 at %.

Further, as shown in FIG. 1B, the onset layer 50 may be inserted between the under layer 40 and the magnetic layer 60. When the under layer 50 comprises a single layer, it may be a nonmagnetic CoCr thin film (film thickness: 30 Å) with hcp structure of Co: 65 at % and Cr: 35 at %.

The magnetic layer 60 is a CoCrPtB alloy thin film. Each content of CoCrPtB is Co: 60 at %, Cr: 20 at %, Pt: 14 at %, B: 6 at %.

After forming the magnetic layer, the segregation promoting layer 70 is formed as a film.

The segregation promoting layers in the Examples 1-5 are CoCrPtTa alloy thin films. Each content of CoCrPtTa is Co: 70 at %, Cr: 19 at %, Pt: 9 at %, Ta: 2 at %.

The segregation promoting layers in the Examples 7-9 are CoCrTa alloy thin films. Each content of CoCrTa is Co: 73 at %, Cr: 22 at %, Ta: 5 at %.

The Comparisons 1-5 are the magnetic recording mediums on which said segregation promoting layers 70 are not formed. They are the like magnetic recording mediums as the examples except that no segregation promoting layers 70 are included therein.

The protection layer 80 is an object for protecting the magnetic layer 60 and comprises a hydrogenised carbon film of the film thickness 45 Å.

The lubricant layer 90 is a liquid lubricant composed of perfluoropolyether with a film thickness of 8 Å and provides a lubrication effect between a magnetic head and the magnetic recording medium.

Still further, the film thicknesses of the magnetic layers and the segregation promoting layers in the Examples 1-5, 7-9, and the Comparisons 1-5 are listed in Table 1.

TABLE 1

| | | Segregation | | | | | | | |
|---|---|---|---|---|---|---|---|---|---|
| | Magnetic | promoting | Coercive | | | | | | |
| | layer film | layer film | force | | Coercive | Signal | O/W | NLTS | S/N |
| | thickness | thickness | Hc | Mrt | squareness | output | property | property | ratio |
| Unit | A | A | Oe | memu/cm² | S* | mVₚₚ | (−dB) | (−dB) | dB |
| Comparison 1 | 105 | No | 3443 | 0.29 | 0.64 | 1.767 | 37.3 | 18.4 | 27.7 |
| Comparison 2 | 114 | segregation | 3491 | 0.33 | 0.65 | 1.932 | 35.9 | 18.1 | 27.5 |
| Comparison 3 | 128 | promoting | 3612 | 0.37 | 0.66 | 2.122 | 34.2 | 17.7 | 27.4 |
| Comparison 4 | 149 | layer | 3636 | 0.43 | 0.67 | 2.312 | 32.5 | 16.8 | 26.9 |
| Comparison 5 | 158 | | 3619 | 0.48 | 0.69 | 2.355 | 31.5 | 16.7 | 26.4 |
| Example 1 | 105 | 5 | 3558 | 0.30 | 0.66 | 1.773 | 36.9 | 24.5 | 28.4 |
| Example 2 | 105 | 18 | 3500 | 0.38 | 0.68 | 2.126 | 36.1 | 23.8 | 27.6 |
| Example 3 | 105 | 31 | 3495 | 0.43 | 0.69 | 2.295 | 35.2 | 23.2 | 27.1 |
| Example 4 | 105 | 49 | 3492 | 0.52 | 0.70 | 2.432 | 34.3 | 22.4 | 26.4 |
| Example 5 | 105 | 70 | 3490 | 0.58 | 0.71 | 2.529 | 33.4 | 20.7 | 25.4 |
| Example 7 | 105 | 9 | 3499 | 0.31 | 0.66 | 1.821 | 37.0 | 22.5 | 28.2 |
| Example 8 | 105 | 32 | 3480 | 0.43 | 0.69 | 2.190 | 35.1 | 22.4 | 27.5 |
| Example 9 | 105 | 48 | 3472 | 0.51 | 0.70 | 2.449 | 33.9 | 20.9 | 26.8 |

Then, the manufacturing method of the magnetic recording medium including the above-mentioned structure will be described.

First, a main surface of the substrate chemically reinforced by an ion exchange process is mirror-polished (Rmax=3.2 nm, Ra=0.3 nm) by precision polishing. Next, the pre-coating layer 20, the seed layer 30, the under layer 40, the onset layer 50, the magnetic layer 60, the segregation promoting layer 70, the protection layer 80 were formed on the main surface of this glass substrate by an in-line type spattering apparatus. Then, the lubricant layer 90 was formed on the protection layer 80 by applying a liquid lubricant, which comprised perfluoropolyether by means of dipping process.

Next, the measuring method of magnetic properties and magnetic recording properties will be described.

Coercive force (Hc), Mrt and coercive squareness(S*) were measured (the applied maximum static magnetic field was 5 kOe during measurement) with a VSM (Vibrating Sample Magnetometer).

For signal output (TAA), S/N ratio, O/W property and NLTS property, an read write analyzer (Guzik RWA-1632) manufactured by Guzik Technical Enterprises was used. The magnetic head used in the measurement is a head with a GMR (Giant Magneto Resistance) type regeneration element having a flying height of 20 nm (hereafter, referred to a GMR head). The write track width is 2.0 μm and the read track width is 0.5 μm.

The maximum recording density (1F) was chosen as 520 kfci.

As to the signal output (TAA), the read output was observed at 12F recording density (43.4 kfci).

After carrier signals were recorded at 1F recording density (520 kfci) on the recording medium, the S/N ratio was calculated according to the observation of medium noise with a spectroanalyzer in the range between DC frequency and 1.2 times frequency of 1F.

The S/N ratio can generally contribute 2 Gbit/inch2 increase to recording density by 0.5 dB increase thereof.

After carrier signals were recorded at 12F recording density and then carriers were overwritten at 1F recording density, the O/W property was obtained by measuring the read output of the former carriers recorded at 12F recording density and the residual read output of the carriers overwritten at 1F after recording at 12F.

As to the NLTS property, a fifth harmonic method was used.

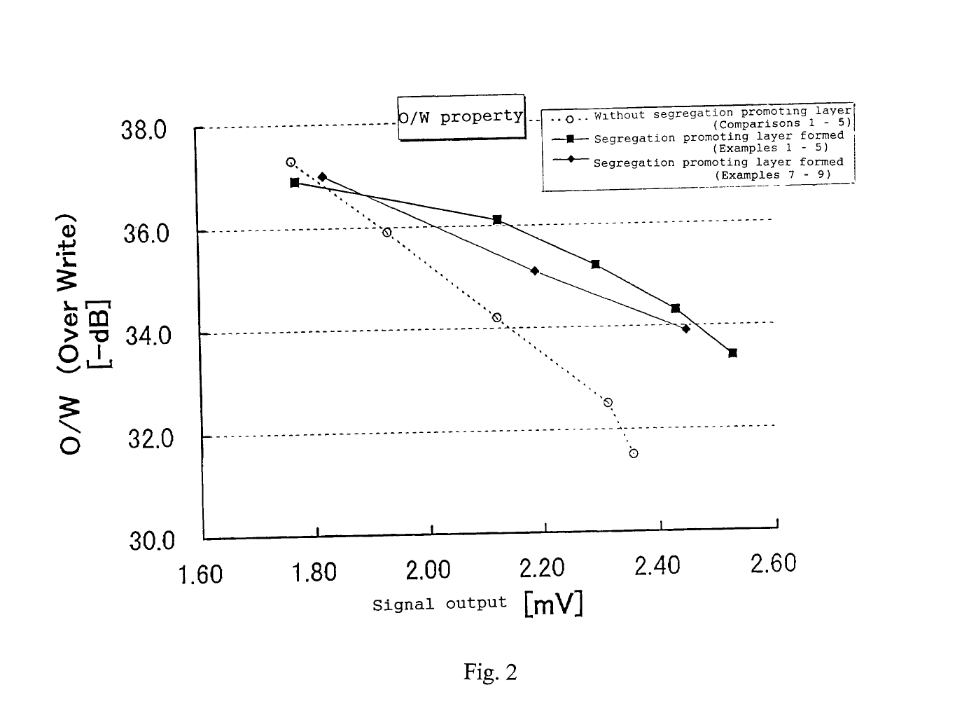

The results of magnetic properties and magnetic recording properties of the Examples 1-5, 7-9, and the Comparisons 1-5 are shown in FIG. 2-FIG. 6. The values used in FIG. 2-FIG. 6 are listed in Table 1.

FIG. 2 is a graph showing the relationship between readout output of the signals recorded on the magnetic recording medium and O/W property. The recording density of output recording signals of the horizontal axis is 43.4 kfci. In the figure, it is shown that the higher located in the graph the O/W properties are, the more enhanced they are. The Improving effect of the formation of the segregation promoting layer on the O/W property has been recognized.

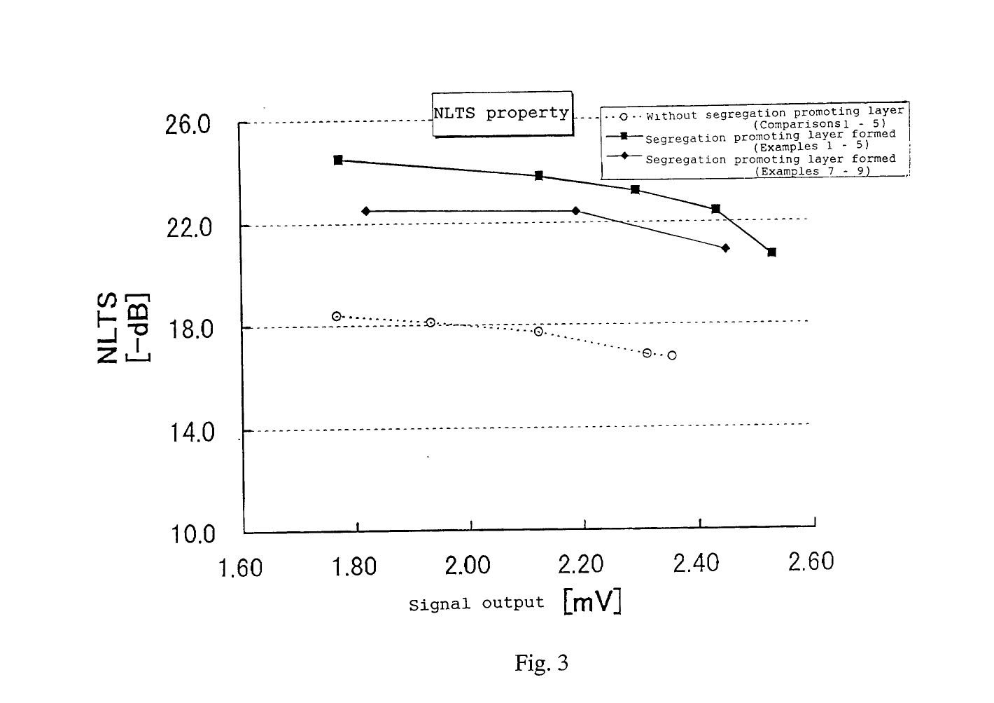

FIG. 3 is a graph showing the improving effect on the NLTS property. The recording density of output recording signals of the horizontal axis is 43.4 kfci. In the figure, it is shown that the higher located in the graph the NLTS properties are, the more enhanced they are. The Improving effect of the formation of the segregation promoting layer on the NLTS property has been recognized.

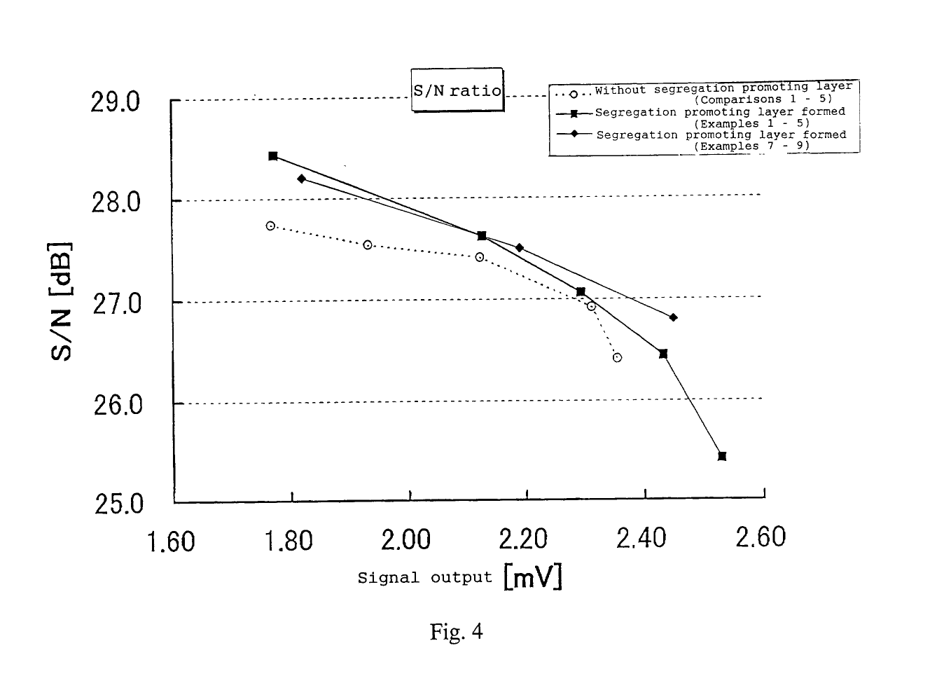

FIG. 4 is a graph showing the relationship between output of signals and the S/N ratio.

The recording density of output recording signals of the horizontal axis is 43.4 kfci. In the figure, it is shown that the higher located in the graph the S/N ratio is, the more enhanced it is.

Enhancement of the S/N ratio has been realized via the formation of the segregation promoting layer and the large enhancement effect on the S/N ratio was recognized especially in the small signal output region which is a low Mrt range advantageous to increasing recording density.

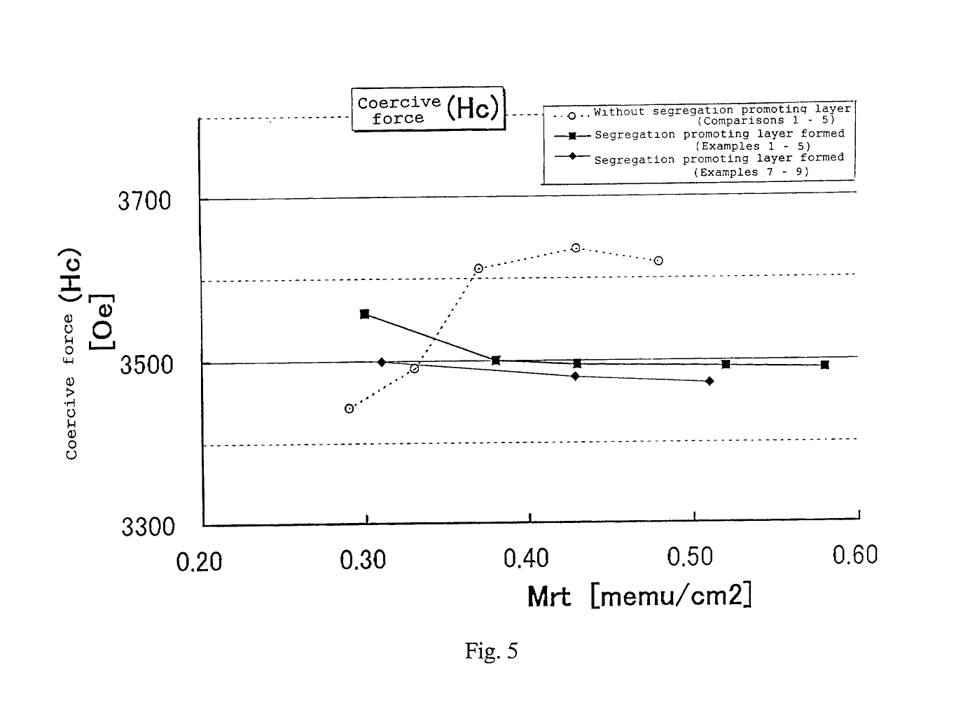

FIG. 5 is a graph showing the relation between the Mrt and the coercive force(Hc). The case where the segregation promoting layer is formed shows stable coercive force compared to that in the case where no segregation promoting layer is formed, and it was recognized that variations of the coercive force against process variation are suppressed to a small extent and a yield of the manufacturing process is increased by the formation of the segregation promoting layer.

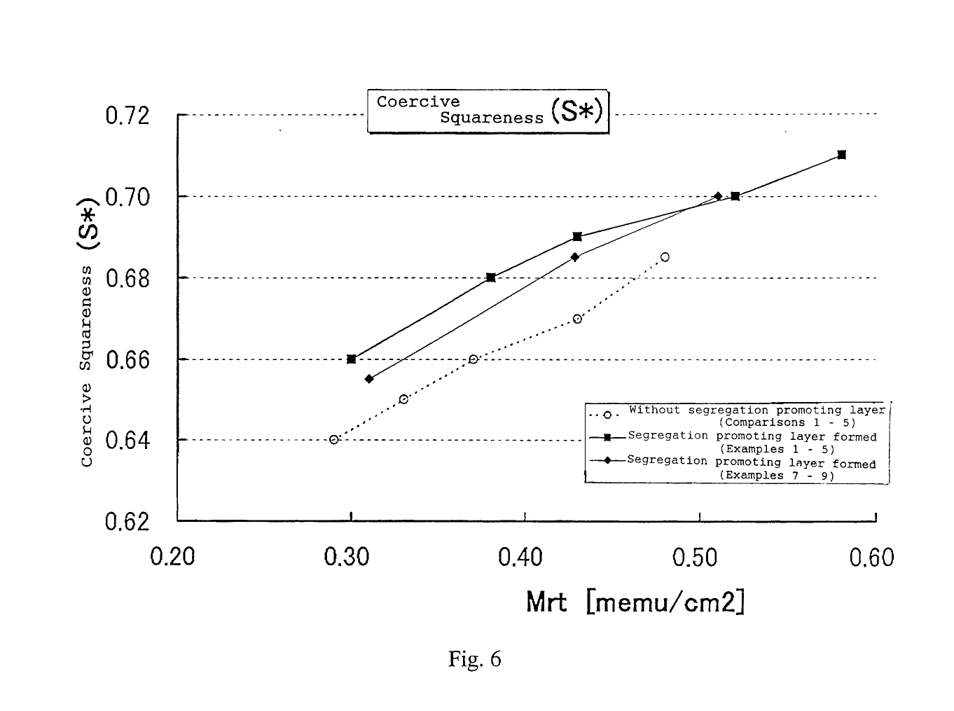

FIG. 6 is a graph showing the relation between the Mrt and the coercive squareness(S*). In the figure, it is shown that the higher located in the graph the coercive squareness(S*) is, the more enhanced it is.

It is seen that the coercive squareness(S*) has been enhanced by forming the segregation promoting layer.

As described above in the description of FIG. 2-FIG. 6, in the case where the segregation promoting layer is formed (Examples 1-5, 7-9) a magnetic recording medium having more enhanced recording properties such as an O/W property, an NLTS property, higher S/N ratio, being released from mutual tradeoff restraint and easy to increase recording density, in comparison with the conventional mediums with no segregation promoting layer (Comparisons 1-5), has been obtained.

Further, the magnetic recording mediums in the Example 1-5 and the Example 7-9 showed excellent resistance against thermal fluctuation which satisfied the prescribed standard.

### EXAMPLE 6

The Example 6 is a magnetic recording medium having such a multi-layered segregation promoting layer that a segregation promoting layer comprising a CoCrPtTaB alloy (film thickness 20 Å) was inserted between the segregation promoting layer and the protection layer in the Example 2, as to provide a segregation promoting layer to which B was added on the magnetic head side of the segregation promoting layer. Except this point, it is the like magnetic recording medium as the Example 2 and the manufacturing method is also alike.

Each magnetic property and magnetic recording property of the Example 6 was as follows.

Hc was 35500 e, Mrt was 0.4 memu/cm² and S* was 0.68.

Signal output was 2.290 mvpp, S/N ratio was 28.2 dB, O/W property was 36.6 (−dB) and NLTS property was 24.3 (−dB). It was a magnetic recording medium in which the effect of forming the segregation promoting layer was more excellent than the result with no segregation promoting layer listed in Table 1 (Comparisons) and the various properties are improved better than those in the Example 2.

Further, the CoCrPtTaB alloy concerned contains Co: 63.5 at %, Cr: 20 at %, Pt: 10 at %, Ta: 0.5 at % and B: 6 at %.

Moreover, the resistance against thermal fluctuation was excellent satisfying the prescribed standard. About the Comparison 3 (without a segregation promoting layer), the Example 2 (with a segregation promoting layer) and the Example 6 (B added on the surface of a segregation promoting layer), AC medium noise was evaluated. The AC medium noise was obtained by measuring normalized medium noise varying carrier signal recording density. The measuring method of the normalized medium noise is the same as the S/N ratio measuring method except the conditions of carrier signal recording density. The carrier signal recording density was varied from near DC (20 kfci) to AC frequency range (near 500 kfci). The medium noise observed at each carrier signal recording density was converted to the normalized medium noise by normalizing itself with said 12F signal read output. The normalized medium noise is i.e. a measure corresponding to the S/N ratio because it is normalized with the 12F signal read output value.

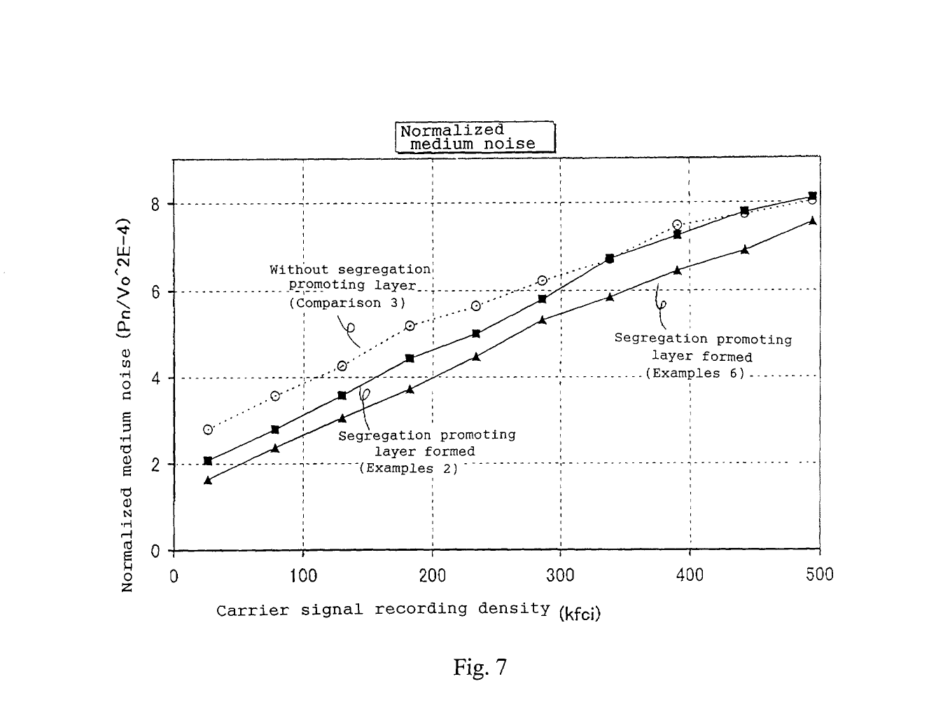

The result is shown in FIG. 7. In the unit of the normalized medium noise, Pn refers to an observed power of medium noise and V₀ is a said signal read output value.

From FIG. 7, it is first seen that S/N ratio improving effect of the segregation promoting layer is mainly obtained by reduction of DC medium noise in comparison between the Comparison 3 (without a segregation promoting layer) and the Example 2 (with a segregation promoting layer).

The reason is because the value of the medium noise near DC (20 kfci) in FIG. 7 is selectively reduced from that in AC frequency range (near 500 kfci) by means of forming the segregation promoting layer. Namely, it may be expressed that the segregation promoting layer has improved selectively the DC medium noise.

Secondly, in comparison between the Example 2 (with a segregation promoting layer) and the Example 6 (B added on the surface of a segregation promoting layer), it is seen that S/N ratio improving effect of adding B to the segregation promoting layer is mainly obtained by reduction of AC medium noise.

Because the value of the medium noise in AC frequency range (near 500 kfci) in FIG. 7 is selectively reduced from that near DC (20 kfci) by means of adding B to the segregation promoting layer. Namely, it may be expressed that the addition of B to the segregation promoting layer has improved selectively the AC medium noise.

As described above, by formation of the segregation promoting layer and addition of B to the segregation promoting layer, has been obtained a magnetic recording medium with high S/N ratio where both DC medium noise and AC medium noise were reduced simultaneously.

Further, using the segregation promoting layer according to the present invention, it is possible to control cut width of DC medium noise and cut width of AC medium noise respectively, and balance of cut width of DC medium noise and AC medium noise can be controlled appropriately depending on the purpose required on the basis of HDD designing.

### EXAMPLE 10

Next, manufactured was a magnetic recording medium having a structure of an AFC film where a magnetic layer was separated with a nonmagnetic substance in order to enhance resistance against thermal fluctuation (Example 10).

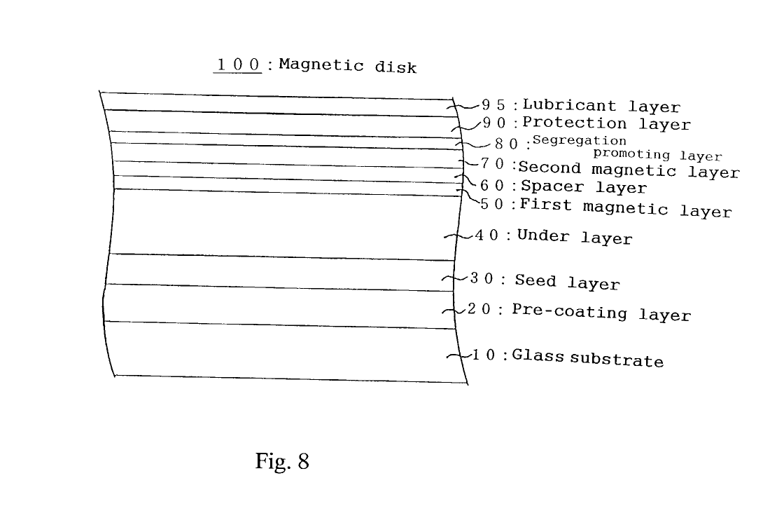

FIG. 8 is a diagram showing a film structure of the magnetic recording medium according to the Example 10. As shown in FIG. 10, the magnetic recording medium of the Example 10 is the one wherein a pre-coating layer 20, a seed layer 30, an under layer 40, a first magnetic layer (a lower magnetic layer) 50, a spacer layer 60, a second magnetic layer (an upper magnetic layer) 70, a segregation promoting layer 80, a protection layer 90 and a lubricant layer 95 are formed sequentially on a substrate (a glass substrate) 10. The glass substrate 10 comprises a chemically reinforced aluminosilicate glass and its surface is mirror-polished in the surface roughness of a maximum height Rmax=3.2 nm, an average surface roughness Ra=0.3 nm (measured with an atomic force microscope).

The pre-coating layer 20 comprises a CrTi amorphous layer (film thickness 300 Angstrom (Å)). An atomic compositional ratio of Cr and Ti in the alloy film is 55:45. The seed layer 30 comprises an AlRu thin film (film thickness 250 Angstrom). An atomic compositional ratio is 50:50. The under layer 40 is a CrW thin film (film thickness 100 Angstrom) and is disposed to make a crystal structure and orientation property of the magnetic layer better. The under layer 40 comprises a compositional ratio of Cr: 90 at % and W: 10 at %. Further, the under layer 40 was formed as a film by spattering under a mixed gas atmosphere of 0.75% CO₂ and Ar in order to promote refininement of the crystal grains of the CrW under layer. The first magnetic layer 50 is a CoCr alloy with a ferromagnetic hcp structure and film thickness: 25 Angstrom, Co: 86 at %, Cr: 14 at %. The spacer layer 60 is a Ru film (film thickness 7 Angstrom) with a hcp nonmagnetic structure. Still further, The second magnetic layer 70 is a ferromagnetic CoCrPtB alloy (film thickness 143 Angstrom) thin film with hcp structure, and the contents of Co, Cr, Pt, B are Co: 59 at %, Cr: 20 at %, Pt: 13 at % and B: 8 at % respectively.

IN the present example, disposed is an AFC film structure comprising a first magnetic layer 50 composed of a ferromagnetic material for controlling anti-ferromagnetic exchange interaction, a second magnetic layer 70 composed of a ferromagnetic material and a spacer layer 60 composed of a nonmagnetic substance being formed between said first magnetic layer 50 and said second magnetic layer 70 for inducing the anti-ferromagnetic exchange interaction. The segregation promoting layer 80 is formed on the second magnetic layer 70. The segregation promoting layer 80 is a CoCrPtTa alloy thin film (film thickness 12 Angstrom) with a hcp structure and the contents of Co, Cr, Pt and Ta are Co: 71 at %, Cr: 18 at %, Pt: 8 at % and Ta: 3 at %, respectively. The protection layer 90 comprises a hydrogenised carbon film having a film thickness of 45Angstrom for preventing degradation of the magnetic layer by contact with a magnetic head. The lubricant layer 95 comprising a perfluoropolyether liquid lubricant relieves the contact with the magnetic head. Additionally, the film thickness is 8 Angstrom. As to other points, the magnetic recording medium is manufactured by the similar method to that in the Example 1.

Further, the results are listed in Table 2.

TABLE 2

| | Coercive | | Coercive | Signal | O/W | NLTS | S/N |
|---|---|---|---|---|---|---|---|
| | force Hc | Mrt | squareness | output | property | property | ratio |
| | Oe | memu/cm² | S* | mVpp | (−dB) | (−dB) | dB |
| Comparison 6 | 3844 | 0.29 | 0.78 | 1.769 | 35.2 | 18.0 | 28.5 |
| Example 10 | 3752 | 0.27 | 0.78 | 1.696 | 38.7 | 25.1 | 28.6 |

### COMPARISON 6

Then, manufactured was a magnetic recording film where the segregation promoting layer 80 in the Example 10 was omitted. Therein, a film thickness of a second magnetic layer 70 was 152 Angstrom. Except this point, it is a similar magnetic recording medium to the Example 10 manufactured by a method similar to that of the Example 10.

The results are listed in Table 2.

As listed in Table 2, it is seen that the present invention is particularly suitable to a magnetic recording medium with an AFC film structure because the O/W property, the NLTS property and the S/N ratio have been improved by disposing the segregation promoting layer.

In Table 3, listed are the results of measuring the resistance against thermal fluctuation of the magnetic recording mediums in the Example 1, Example 6, Example 7, Example 10, Comparisons 1 and Comparison 6.

TABLE 3

| | Signal attenuation due to |
|---|---|
| | thermal fluctuation |
| | (Thermal Decay) |
| | (−dB/decade) |
| Example 1 | 0.16 |
| Example 6 | 0.14 |
| Example 7 | 0.15 |
| Example 10 | 0.07 |
| Comparison 1 | 0.26 |
| Comparison 6 | 0.10 |

The resistance against thermal fluctuation was measured by the following method.

While keeping the magnetic recording medium under the circumstance of 60° C., signals were written on the magnetic recording mediums at the linear recording density of 100 kfci using a GMR head with the write track width of 2.0 μm, the read track width of 0.5 μm and the flying height of 20 nm, and then the amounts of attenuation of the recorded signals attenuating with passage of time were evaluated using a spectroanalyzer. The larger the signal attenuation per unit time is, the more likely to occur thermal fluctuation is, and such a magnetic recording medium may be called one with the low resistance against thermal fluctuation.

From the results in Table 3, it is seen that the signal attenuation can be reduced to a great extent by enhancing the resistance against thermal fluctuation according to the structure of the present invention. The signal attenuation due to thermal fluctuation (Thermal Decay) is preferably suitable to increasing recording density as it gets smaller and smaller. The signal attenuation due to thermal fluctuation is generally required to be at worst less than 0.2 (−dB/Decade) and this is usually adopted as the prescribed standard. It is recognized that the magnetic recording medium of the preset invention shows an excellent resistance against thermal fluctuation, which satisfies the prescribed standard.

As described above, in the present invention the magnetic recording medium excellent in the O/W property and the NLTS property with high coercive force at the same time can be obtained.

Further, both the resistance against thermal fluctuation and the S/N ratio are improved at the same time and the improvement of the SIN ratio has been realized by improving both DC medium noise and AC medium noise. Further, using the segregation promoting layer according to the present invention, it is possible to control cut width of DC medium noise and cut width of AC medium noise respectively, and balance of cut width of DC medium noise and AC medium noise can be controlled appropriately depending on the purpose required on the basis of HDD designing.

What is claimed is:

1. A magnetic recording medium comprising at least:
a substrate;
a magnetic layer formed on the substrate; and
a segregation promoting layer formed on the magnetic layer,
wherein said segregation promoting layer contains segregation promoting elements which diffuse into a surface layer portion of said magnetic layer to promote the isolation of magnetic grains in the surface layer portion.

2. The magnetic recording medium according to claim 1, wherein said segregation promoting layer is made of a material having a higher magnetic permeability than said magnetic layer.

3. The magnetic recording medium according to claim 1 or 2, wherein
said segregation promoting layer is made of a material containing Co and Cr as well as segregation promoting elements consisting of at least one element selected from Ta, W and C,
and among the contents of the elements contained in said segregation promoting layer,
the Cr content is in a range of 10 at % to 30 at % and
the contents of the segregation promoting elements selected from Ta, W and C are in a range of 0.3 at % to 10 at %.

4. The magnetic recording medium described in anyone of the claims from 1 to 3, wherein said magnetic layer is made of a material containing Co, Pt and B, and among the contents of the elements contained in said magnetic layer, the Pt content is in a range of 5 to 20 at % and the B content is in a range of 0.5 at % to 10 at %.

5. The magnetic recording medium described in anyone of the claims from 1 to 4, wherein B is added in 0-10 at % to the surface of said segregation promoting layer.

6. The magnetic recording medium described in anyone of the claims from 1 to 5, wherein a film thickness of said segregation promoting layer is 5-70Å and still smaller than a film thickness of said magnetic layer.

7. A magnetic recording medium comprising at least:
a substrate;
a magnetic layer formed on the substrate; and
an upper layer formed on the magnetic layer,
wherein said magnetic layer is made of a material containing Co, Pt and B, and among the contents of the elements contained in said magnetic layer, the Pt content is in a range of 5 to 20 at % and the B content is in a range of 0.5 at % to 10 at %; and said upper layer is made of a material containing Co and Cr, and also at least one element selected from Ta, W and C, and among the contents of the elements contained in said upper layer, the Cr content is in a range of 10 at % to 30 at % and the contents of the elements selected from Ta, W and C are in a range of 0.3 at % to 10 at %.

8. The magnetic recording medium according to claim 7, wherein B is added in 0-10 at % to a surface of said upper layer.

9. The magnetic recording medium according to claims 7 or 8, wherein a film thickness of said upper layer is 5-70 Å and still smaller than a film thickness of said magnetic layer.

10. The magnetic recording medium according to claims 1 or 7, wherein said magnetic layer is separated by a spacer layer composed of a nonmagnetic substance, and the separated magnetic layers are in anti-ferromagnetic coupling state with each other.
